(19) United States
(12) Patent Application Publication
(10) Pub. No.: US 2014/0125551 A1
(43) Pub. Date: May 8, 2014

(54) METHOD FOR ASSEMBLING HOUSING OF ELECTRONIC DEVICE AND HOUSING ASSEMBLY OF ELECTRONIC DEVICE

(71) Applicants: Yu-Ju Chen, Taipei City (TW); Shih-Wei Li, Taipei City (TW); Chien-Chun Wu, Taipei City (TW)

(72) Inventors: Yu-Ju Chen, Taipei City (TW); Shih-Wei Li, Taipei City (TW); Chien-Chun Wu, Taipei City (TW)

(21) Appl. No.: 13/711,635

(22) Filed: Dec. 12, 2012

(30) Foreign Application Priority Data
Nov. 5, 2012 (TW) 101141030

(51) Int. Cl. H01Q 1/22

(52) U.S. Cl. CPC H01Q 1/22
USPC 343/878; 29/600

(57) ABSTRACT

A method for assembling a housing of an electronic device including the following steps is provided. An antenna pattern layer and an adhesive layer is provided, wherein the antenna pattern layer has a first surface opposite a second surface, and the adhesive layer is disposed on the first surface of the antenna pattern layer. A plastic frame is formed on the second surface of the antenna pattern layer by injection molding. The antenna pattern layer and the plastic frame are attached on a substrate via the adhesive layer. In addition, a housing assembly of an electronic device is also provided.

### CROSS-REFERENCE TO RELATED APPLICATION

This application claims the priority benefit of Taiwan application serial no. 101141030, filed on Nov. 5, 2012. The entirety of the above-mentioned patent application is hereby incorporated by reference herein and made a part of this specification.

### BACKGROUND

1. Field of the Invention

The invention relates to a method for assembling a housing and a housing assembly thereof. More particularly, the invention relates to a method for assembling a housing of an electronic device and a housing assembly thereof.

2. Description of Related Art

Currently, general public communications have slowly entered an era of wireless communication, and therefore, utilization rates of electronic devices, such as notebook computer, smart phone and tablet PC, in various occasions have also become increasingly high and more diversified. Under a circumstance of increasing popularity in wireless network, a user, in addition to using a network cable to gain the Internet access, may also connect to the Internet via the wireless network.

In order to let the user to obtain a better signal quality, the electronic device is often required to be disposed with an antenna therein for receiving signals emitted from a wireless network station. In general, a conventional electronic device due to a strength factor of a housing has often adopted a metal as the material of the housing. However, the reception of the antenna would be affected by the shielding effect of the metal. Therefore, on an housing of a conventional notebook computer, in addition to the metal material, an additional spot corresponded to the antenna is bound to be reserved and replaced with a plastic material in order to not affect the reception of the antenna. As a result, a cost for producing and assembling the plastic parts must be additionally added when manufacturing the housing.

Another conventional method for assembling the antenna is to adopt glass as the material of the housing, whereas the antenna is locked at a frame of the electronic device while the glass housing and the frame of electronic device are combined together via a double-sided adhesive. Nevertheless, this method not only is time-consuming but also restricts a configuration space the antenna.

### SUMMARY OF THE INVENTION

The invention provides a method for assembling a housing of an electronic device configured to solve a problem produced when attaching an antenna pattern layer while not limiting a configuration space of the antenna pattern layer.

The invention provides a housing assembly of an electronic device capable of enhancing a space utilization rate of an antenna pattern layer.

The invention provides a method for assembling a housing of an electronic device including the following steps. An antenna pattern layer and an adhesive layer are provides, wherein the antenna pattern layer has a first surface opposite a second surface, and the adhesive layer is disposed on the first surface of the antenna pattern layer. Next, a plastic frame is formed on the second surface of the antenna pattern layer by injection molding. The antenna pattern layer and the plastic frame are attached on a substrate via the adhesive layer.

The invention also provided a housing assembly of an electronic device. The housing assembly of the electronic device includes an antenna pattern layer, an adhesive layer, a plastic frame and a substrate. The antenna pattern layer has a first surface opposite a second surface. The adhesive layer is disposed on the second surface of the antenna pattern layer. The plastic frame is assembled on the second surface of the antenna pattern layer. The substrate is attached to the antenna pattern layer via the adhesive layer.

According to the foregoing, as compared to a conventional method for assembling the housing of the electronic device and a housing assembly thereof, the antenna pattern layer and the adhesive layer of the invention are integrated together, the plastic frame is firstly formed on the antenna pattern layer, and the antenna pattern layer and the plastic frame are then attached on the substrate via the adhesive layer without using of an additional double-sided adhesive or spot glue.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a literal flow chart schematically illustrating a method for assembling a housing of an electronic device according to an embodiment of the invention.

FIG. 2A through FIG. 2G are assembly flow diagrams schematically illustrating the method for assembling the housing of the electronic device in FIG. 1.

### DETAILED DESCRIPTION OF DISCLOSED EMBODIMENTS

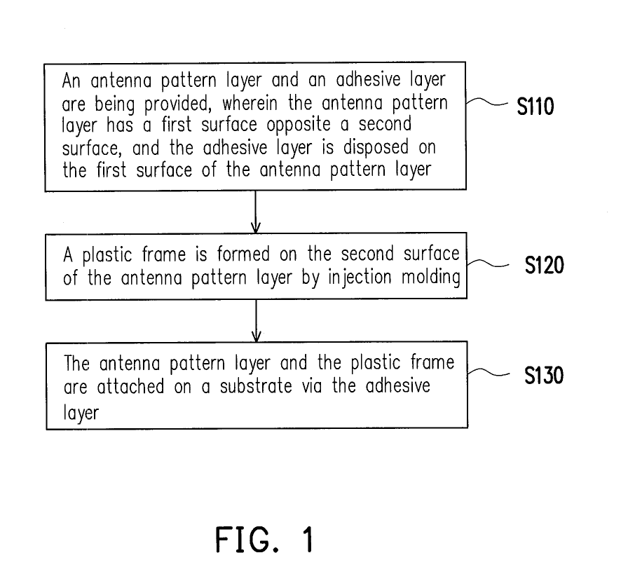

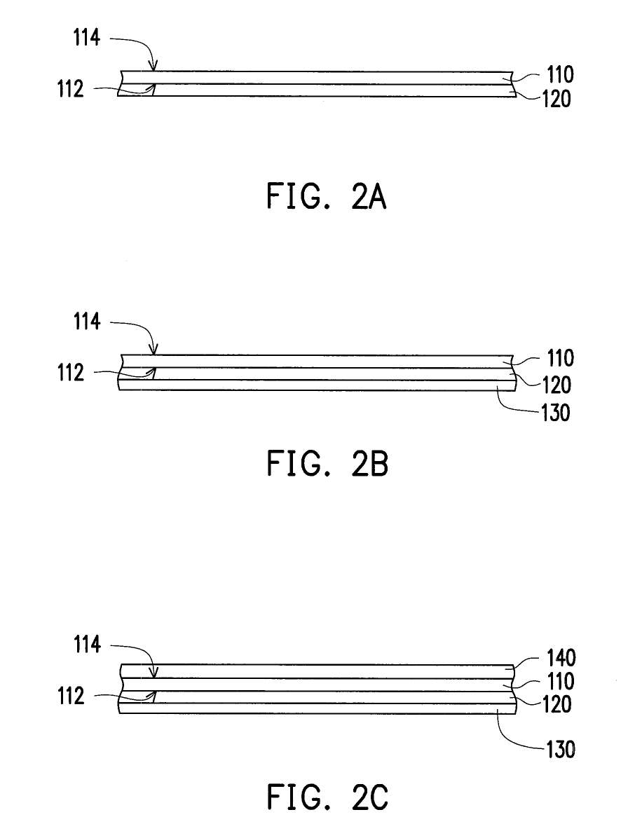

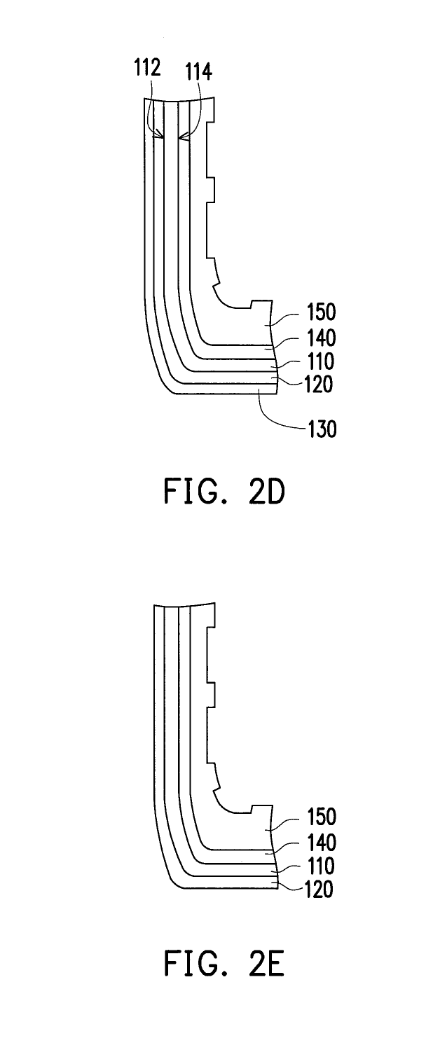

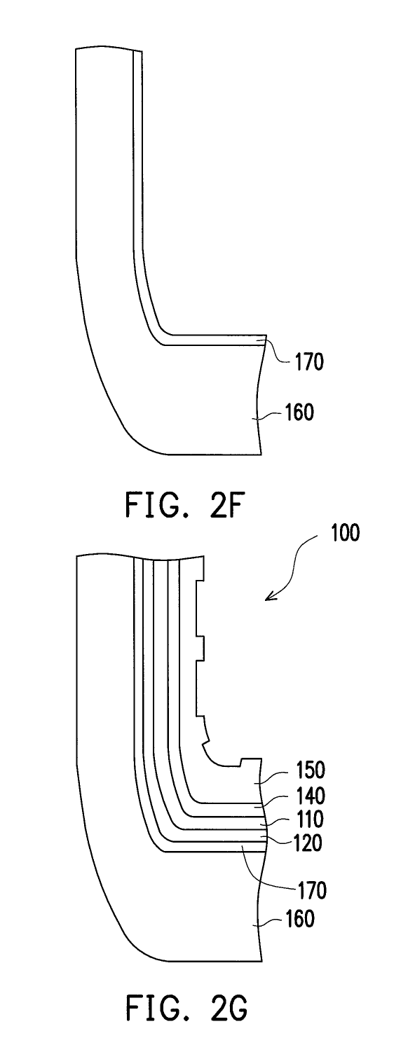

FIG. 1 is a literal flow chart schematically illustrating a method for assembling a housing of an electronic device according to an embodiment of the invention. FIG. 2A through FIG. 2G are assembly flow diagrams schematically illustrating the method for assembling the housing of the electronic device in FIG. 1. Referring to FIG. 1 and FIG. 2A, an antenna pattern layer 110 and an adhesive layer 120 are being provided in the method for assembling the housing of the electronic device of the present embodiment, as shown in FIG. 2A, wherein the antenna pattern layer 110 has a first surface 112 opposite a second surface 114. Now, the adhesive layer 120 is disposed on the first surface 112 of the antenna pattern layer 110 (step S110). A material of the antenna pattern layer 110 is, for example, copper, nickel, gold, silver, platinum and an alloy combination thereof, and may be formed through a means of electroplating, vapor deposition, sputtering, printing, coating, etching and so forth. In addition, a thickness of the antenna pattern layer 110 is, for example, 1 to 20 um.

It is to be explained that, in the present embodiment, a heat resistant temperature of the adhesive layer 120 is greater than 230 degrees C., and an adhesive layer 120 is produced by adopting materials of high heat resistant temperature, such as acrylic adhesive, acrylic foam, polyolefin adhesive, polyolefin foam or a combination of adhesive and foam. In detail, the adhesive layer 120, for example, has the top and bottom layers being the acrylic adhesive, and then the acrylic foam may be added between the top and bottom layers so as to provide the adhesive layer 120 with flexibility. In addition, a thickness of the adhesive layer 120 is, for example, 20 um to 2.0 mm.

The step S110 of providing the antenna pattern layer 110 and the adhesive layer 120 includes the following steps. Firstly, a release layer 130 is disposed on the adhesive layer 120, as shown in FIG. 2B. In detail, a material of the release layer 130 includes silane or fluorosilane, and a thickness of the release layer 130 is, for example, 0.1 to 5 um. Next, a protective layer 140 is disposed on the second surface 114 of the antenna pattern layer 110, as shown in FIG. 2C. A material of the protective layer 140 includes polyester adhesive, acrylic adhesive and polyolefin adhesive. In addition, a thickness of the protective layer 140 is, for example, 5 to 20 um. In other embodiments, the protective layer 140 may be firstly disposed on the second surface 114 of the antenna pattern layer 110, and the release layer 130 is then disposed on the adhesive layer 120. As such, the sequential order of the assembling method in the present embodiment is not limited thereto.

Next, referring to FIG. 2D, a plastic frame 150 is formed on the second surface 114 of the antenna pattern layer 110 by injection molding (step S120). Under this assembly process, the material of the adhesive layer 120 adopted in the present embodiment has a heat resistant temperature greater than 230 degrees C., and thus, may withstand a higher temperature of heat. As such, when performing the step 120 of injection molding, an adhesion of the adhesive layer 120 is not going to be lost due to the high temperature.

Referring to FIG. 2G, the antenna pattern layer 110 and the plastic frame 150 are attached on a substrate 160 via the adhesive layer 120 (step S130). The substrate 160 is, for example, produced from a material such as glass, acrylic, polycarbonate, ABS resin, polystyrene, nylon resin, epoxy resin and ceramic. As a result, the assembly process of the housing of the electronic device is completed.

As compared to a conventional method for assembling the housing of the electronic device, the antenna pattern layer 110 and the adhesive layer 120 of the present embodiment are integrated together, the plastic frame 150 is firstly formed on the antenna pattern layer 110, and the antenna pattern layer 110 and the plastic frame 150 are then attached on the substrate 160 via the adhesive layer 120 without using of an additional double-sided adhesive or spot glue. In addition, the plastic frame 150 of the present embodiment is formed on the antenna pattern layer 110 by a means of in-mold injection, so that the antenna pattern layer 110 is transformed from a plane shape to a three-dimensional shape in order to produce an antenna pattern layer 110 with curved surface (three-dimensional) or antenna pattern layer 110 with plane. Therefore, this antenna pattern layer 110 with curved surface (three-dimensional) or antenna pattern layer 110 with plane can be free from a shape restriction of the substrate 160, and may arbitrarily be attached to any appropriate position on the substrate 160; and thus, a configuration space of the antenna pattern layer 110 may be enhanced.

Specifically, referring to FIG. 2E, in the step S130 of attaching the antenna pattern layer 110 and the plastic frame 150 on the substrate 160 via the adhesive layer 120, the method for assembling the housing of the electronic device further includes removing the release layer 130. For instance, a decorative ink layer 170 may firstly be formed on the substrate 160, as shown in FIG. 2F. The decorative ink layer 170 is, for example, a white ink layer or a black ink layer, wherein the white ink layer may provide a pure white appearance, and an effect of the black ink layer may block the periphery of the substrate 160 from having a light leakage or prevent internal components from being seen through viewing the substrate 160. However, the color and structure of the decorative ink layer 170 may be freely modified by those skilled in the art for the purpose of achieving a decorative effect in demand.

In the present embodiment, an assembly of a housing of an electronic device 100 may be adopted to execute the method for assembling the housing of the electronic device. Referring to FIG. 2G, the assembly of the housing of the electronic device 100 includes an antenna pattern layer 110, an adhesive layer 120, a plastic frame 150 and a substrate 160. The antenna pattern layer 110 has a three-dimensional shape. The antenna pattern layer 110 has a first surface 112 opposite a second surface 114. In detail, a material of the antenna pattern layer 110 is, for example, copper, nickel, palladium, gold, silver, platinum and an alloy combination thereof, and the antenna pattern layer 110 may be formed by means of electroplating, vapor deposition, sputtering, printing, coating, etching and so forth. In addition, a thickness of the antenna pattern layer 110 is, for example, 1 to 20 um.

The adhesive layer 120 is disposed on the first surface 112 of the antenna pattern layer 110, and a thickness of the adhesive layer 120 is, for example, 16 to 250 um. The plastic frame 150 is assembled on the second surface 114 of the antenna pattern layer 110. The assembly of the housing of the electronic device 100 further includes a protective layer 140. The protective layer 140 is disposed between the plastic frame 150 and the second surface 114 of the antenna pattern layer 110. A material of the protective layer 140 includes polyester adhesive, acrylic adhesive and polyolefin adhesive, and a thickness of the protective layer 140 is, for example, 5 to 20 um.

The substrate 160 is attached to the antenna pattern layer 110 via the adhesive layer 120. In addition, the assembly of the housing of the electronic device 100 further includes a decorative ink layer 170. The decorative ink layer 170 is disposed between the adhesive layer 120 and the substrate 160, and the invention does not limit the color and structure of the decorative ink layer 170.

Under this configuration, as compared to the conventional assembly of the housing of the electronic device, the antenna pattern layer 110 of the present embodiment is attached to the substrate 160 via the adhesive layer 120 without using of an additional double-sided adhesive or spot glue, thereby enhancing a space utilization rate of the antenna pattern layer 110. In addition, the plastic frame 150 is, for example, assembled on the second surface 114 of the antenna pattern layer 110 by injection molding, and the adhesive layer 120 is produced by adopting materials of high heat resistant temperature, such as acrylic adhesive, acrylic foam, polyolefin adhesive, polyolefin foam and so forth. Accordingly, the material of the adhesive layer 120 adopted in the present embodiment has a heat resistant temperature greater than 230 degrees C., and thus, may withstand a higher temperature of heat. Therefore, even if an injection molding is being performed, an adhesion of the adhesive layer 120 is not going to be lost due to the high temperature.

In summary, as compared to the conventional method for assembling the housing of the electronic device and the conventional assembly of the housing of the electronic device, the antenna pattern layer and the adhesive layer of the invention is integrated together, the plastic frame is firstly formed on the antenna pattern layer, and the antenna pattern layer and the plastic frame are then attached on the substrate the via the adhesive layer without using of an additional double-sided adhesive or spot glue.

In addition, the plastic frame of the present embodiment is formed on the antenna pattern layer by the means of in-mold injection molding, so as to produce the antenna pattern layer with curved surface (three-dimensional) or plane. As a result, this antenna pattern layer with curved surface (three-dimensional) or antenna pattern layer with plane can be free from the shape restriction of the substrate, and may arbitrarily be attached to any appropriate position on the substrate; and thus, the configuration space of the antenna pattern layer may be enhanced.

Moreover, the material of the adhesive layer adopted in the invention has the heat resistant temperature greater than 230 degrees C., and thus, may withstand the higher temperature of heat. As such, when performing the step of injection molding, the adhesion of the adhesive layer is not going to be lost due to the high temperature, so as to ensure that the adhesive layer may be attached to the substrate.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for assembling a housing of an electronic device comprising:
providing an antenna pattern layer and an adhesive layer, wherein the antenna pattern layer has a first surface opposite a second surface, and the adhesive layer is disposed on the first surface of the antenna pattern layer;
forming a plastic frame on the second surface of the antenna pattern layer by injection molding; and
attaching the antenna pattern layer and the plastic frame via the adhesive layer.

2. The method for assembling the housing of the electronic device recited in claim 1, wherein in the step of forming the plastic frame on the second surface of the antenna pattern layer by injection molding, the antenna pattern layer transforms from a plane shape to a three-dimensional shape.

3. The method for assembling the housing of the electronic device recited in claim 1, wherein a heat resistant temperature of the adhesive layer is greater than 230 degrees C.

4. The method for assembling the housing of the electronic device recited in claim 1, wherein a material of the adhesive layer comprises acrylic adhesive, acrylic foam, polyolefin adhesive, polyolefin foam or adhesive plus foam.

5. The method for assembling the housing of the electronic device recited in claim 1, wherein a thickness of the adhesive layer is 20 um to 2.0 mm.

6. The method for assembling the housing of the electronic device recited in claim 1 further comprising:
disposing release layer on the a adhesive layer before forming the plastic frame on the second surface of the antenna pattern layer by injection molding; and
removing the release layer before attaching the antenna pattern layer and the plastic frame on the substrate via the adhesive layer.

7. The method for assembling the housing of the electronic device recited in claim 6, wherein a material of the release layer comprises silane or fluorosilane.

8. The method for assembling the housing of the electronic device recited in claim 6, wherein a thickness of the release layer is 0.1 to 5 um.

9. The method for assembling the housing of the electronic device recited in claim 1 further comprising:
disposing a protective layer on the second surface of the antenna pattern layer before forming the plastic frame on the second surface of the antenna pattern layer by injection molding.

10. The method for assembling the housing of the electronic device recited in claim 9, wherein a material of the protective layer comprises polyester adhesive, acrylic adhesive and polyolefin adhesive.

11. The method for assembling the housing of the electronic device recited in claim 9, wherein a thickness of the protective layer is 5 to 20 um.

12. The method for assembling the housing of the electronic device recited in claim 1 further comprising:
disposing a decorative ink layer on the substrate before attaching the antenna pattern layer and the plastic frame on the substrate via the adhesive layer.

13. The method for assembling the housing of the electronic device recited in claim 1, wherein a material of the substrate comprises glass, acrylic, polycarbonate, ABS resin, polystyrene, nylon resin, epoxy resin and ceramic.

14. The method for assembling the housing of the electronic device recited in claim 1, wherein a material of the antenna pattern, layer comprises copper, nickel, palladium, gold, silver, platinum and an alloy combination thereof.

15. The method for assembling the housing of the electronic device recited in claim 1, wherein a thickness of the antenna pattern layer is 1 to 20 um.

16. The method for assembling the housing of the electronic device recited in claim 1, wherein a formation of the antenna pattern layer comprises electroplating, vapor deposition, sputtering, printing, coating and etching.

17. A housing assembly of an electronic device comprising:
an antenna pattern layer having a first surface opposite a second surface;
an adhesive layer disposed on the first surface of the antenna pattern layer;
a plastic frame assembled on the second surface of the antenna pattern layer; and
a substrate attached to the antenna pattern layer via the adhesive layer.

18. The housing assembly of the electronic device as recited in claim 17, wherein the antenna pattern layer is a three-dimensional shape.

19. The housing assembly of the electronic device as recited in claim 17, wherein a heat resistant temperature of the adhesive layer is greater than 230 degrees C.

20. The housing assembly of the electronic device as recited in claim 17, wherein a material of the adhesive layer comprises acrylic adhesive, acrylic foam, polyolefin adhesive, polyolefin foam or adhesive plus foam.

21. The housing assembly of the electronic device as recited in claim 17, wherein a thickness of the adhesive layer is 20 um to 2.0 mm.

22. The housing assembly of the electronic device as recited in claim 17 further comprising:
a protective layer disposed between the plastic frame and the second surface of the antenna pattern layer.

23. The housing assembly of the electronic device as recited in claim 22, wherein a material of the protective layer comprises polyester adhesive, acrylic adhesive and polyolefin adhesive.

24. The housing assembly of the electronic device as recited in claim 22, wherein a thickness of the protective layer is 5 to 20 um.

25. The housing assembly of the electronic device as recited in claim 17 further comprising:
a decorative ink layer disposed between the adhesive layer and the substrate.

26. The housing assembly of the electronic device as recited in claim 17, wherein a material of the substrate comprises glass, acrylic, polycarbonate, ABS resin, polystyrene, nylon resin, epoxy resin and ceramic.

27. The housing assembly of the electronic device as recited in claim 17, wherein a material of the antenna pattern layer comprises copper, nickel, palladium, gold, silver, zinc, platinum and an alloy combination thereof.

28. The housing assembly of the electronic device as recited in claim 17, wherein a thickness of the antenna pattern layer 1 to 20 um.
